(19) United States
(12) Patent Application Publication
(10) Pub. No.: US 2002/0198288 A1
(43) Pub. Date: Dec. 26, 2002

(54) Dispersions and latexes if polar group modified polymers

(76) Inventors: Dale C Schmidt, Midland, MI (US); John M Warakomski, Midland, MI (US); James E Pate III, Sanford, MI (US)

Correspondence Address: THE DOW CHEMICAL COMPANY, INTELLECTUAL PROPERTY SECTION, P. O. BOX 1967, MIDLAND, MI, 48641-1967, US

(21) Appl. No.: 10/110,918

(22) PCT Filed: Aug. 22, 2001
(86) PCT No.: PCT/US01/26223

(51) Int. Cl. C08K 3/00; C08K 3/40; C08K 9/00

(52) U.S. Cl. 523/217; 524/571; 524/611; 524/494

(57) ABSTRACT

An aqueous dispersion, preferably a latex, of a polar group modified polyphenylene ether or a polar group modified block copolymer of a vinly aromatic monomer and a conjugated diene, said dispersion having a mean, volume average particle size dispersed phase of less than 2.0 μm is disclosed. The latex is particularly suited for use in the formation of a coating on an inorganic filler for use in formation of thermoplastic resin blends or composites.

This invention relates to dispersions and artificial latexes derived from polar group modified polymers. More particularly, the present invention relates to stable dispersions or latexes of such a polymer in a non-oleophilic continuous phase, especially an aqueous, continuous phase. The resulting dispersions and latexes are usefully employed as coatings and paints. In a particularly preferred embodiment, a thin coating of the polar group modified polymer may be applied to a solid material in order to improve its compatibility with additional components of a resin blend containing such material. For example, U.S. Pat. No. 5,391,603 discloses reinforced blends of syndiotactic vinylaromatic polymers containing fibrous reinforcing agents that bear a surface coating of a maleic anhydride- or fumaric acid-grafted polyphenylene ether. The coating could be suitably applied from either a solution or an emulsion.

The following definitions and meanings of terms are provided for purposes of the present description and claims. Stable dispersions contain an internal or dispersed phase in the form of finely divided liquid or solid regions and an external or continuous phase. The two phases are incompatible. If both phases are liquids, the dispersion is known as an emulsion. A solid internal phase dispersed in a liquid continuous phase is referred to as a latex. So long as the continuous phase remains in the form of a thin liquid film that separates adjacent internal phase domains, the internal phase will not normally agglomerate or coalesce. Often, the dispersion can only be formed and stabilized against agglomeration or coalescence by use of a surfactant that promotes compatibility between the continuous phase and the surface of the internal phase domains. If the dispersed phase is represented by an arrangement of spheres of equal radii, the theoretical maximum volume attributable thereto is 0.74, which is the volume fraction of the most compact arrangement of spheres of equal radii. Generally, however, the dispersed phase forms non-spheroidal shapes or contains a range of particle sizes. The internal phase volume fraction for such dispersions may exceed 0.74. Very high internal phase volume fraction dispersions may have dispersed phase volume fractions as high as 0.99. These dispersions are known as high internal phase ratio (HIPR) dispersions. Techniques for forming HIPR dispersions have been disclosed in U.S. Pat. Nos. 5,539,021, 5,688,842, 4,018,426 and elsewhere.

Dispersions of solid polymers in an aqueous liquid external phase (latexes) are well known in the art. They occur naturally or may be prepared from synthetic polymers using one of several techniques. In one method, a polymer is dissolved in an organic liquid solvent, a water-in-oil or oil-in-water emulsion is formed therefrom, and thereafter the organic solvent is removed. Continuous methods for forming latexes from a HIPR emulsion are disclosed in the foregoing U.S. Pat. Nos. 5,539,021 and 5,688,842. A variety of surfactants, including alkaryloxypolyalkyleneoxy-sulfate surfactants were disclosed for use in formation of dispersions in these references.

Forming stable aqueous dispersions of polar functionalized polymers such as the foregoing resins as well as polar group functionalized block copolymers has proven to be difficult in practice in that it has not been possible to select a suitable surfactant able to stabilize the resulting dispersion. In U.S. Pat. No. 5,120,765, it was reported that only certain linear alkyl aromatic sulfonates, out of numerous surfactants tested, were effective to form dispersions of polar group modified block copolymers. After 5 passes through a Microfluidics Model MIIOET Microfluidizer, a dispersion having a dispersed phase with a mean, volume average particle size of 2 μm or less was produced. The dispersion exhibited some separation upon sitting for one week at room temperature, thereby indicating inadequate stability of the dispersion.

As the foregoing example demonstrates, the formation of dispersions having small internal phase domain size, especially dispersions having an internal phase particle size of less than 2.0 μm, from polar group modified polymers has proven to be difficult. Dispersions, especially latexes, having smaller mean, volume average particle size internal phases generally show improved stability. Accordingly, there remains a need to prepare aqueous dispersions, especially latexes, of polar group modified polymers having a mean, volume average particle size dispersed phase of less than 2.0 μm, preferably 1.25 μm or less, more preferably 1.1 μm or less, highly preferably 1.0 μm or less, and most preferably 0.8 μm or less, or even 0.5 μm or less.

According to the present invention, there is provided a dispersion of a polar group modified polyphenylene ether or a polar group modified block copolymer of a vinyl aromatic monomer and a conjugated diene, said dispersion having a mean, volume average particle size dispersed phase of less than 2.0 μm, preferably 1.25 μm or less, more preferably 1.1 μm or less, highly preferably 1.0 μm or less, most preferably, 0.8 μm or less, and most highly preferably, 0.5 μm or less.

In a further embodiment of the present invention, there is provided a latex of a polar group modified polyphenylene or a polar group modified block copolymer of a vinyl aromatic monomer and a conjugated diene, said latex having a mean, volume average particle size dispersed phase of less than 2.0 μm, preferably 1.25 μm or less, more preferably 1.1 μm or less, highly preferably 1.0 μm or less, most preferably, 0.8 μm or less, and most highly preferably, 0.5 μm or less.

In another embodiment of the present invention, there is provided a high internal phase volume dispersion of a polar group modified polyphenylene ether or a polar group modified block copolymer of a vinyl aromatic monomer and a conjugated diene, said dispersion having a mean, volume average particle size dispersed phase of less than 2.0 μm, preferably 1.25 μm or less, more preferably 1.1 μm or less, highly preferably 1.0 μm or less, most preferably, 0.8 μm or less, and most highly preferably, 0.5 μm or less.

In yet another embodiment of the present invention, there is provided a high internal phase volume latex of a polar group modified polyphenylene ether or a polar group modified block copolymer of a vinyl aromatic monomer and a conjugated diene, said latex having a mean, volume average particle size dispersed phase of less than 2.0 μm, preferably 1.25 μm or less, more preferably 1.1 μm or less, highly preferably 1.0 μm or less, most preferably, 0.8 μm or less, and most highly preferably, 0.5 μm or less.

In still another embodiment of the present invention, an inorganic filler, especially a fibrous reinforcing agent, for use in a thermoplastic composite having a polar functionalized polyphenylene ether or a polar group modified block copolymer of a vinyl aromatic monomer and a conjugated diene coated on the surface thereof is prepared by contacting an inorganic filler, preferably a fibrous reinforcing agent, optionally having one or more sizing or compatibilizing compounds deposited on the surface thereof, with a latex of a polar group modified polyphenylene ether, or a polar group modified block copolymer of a vinyl aromatic monomer and a conjugated diene, and thereafter drying the latex.

More particularly, there is provided a composition comprising: 1) a thermoplastic resin and 2) an inorganic filler, characterized in that the filler initially comprises a coating on the surface thereof formed from the above latexes.

In a final embodiment of the present invention, there are provided processes for forming the foregoing dispersions and latexes. In all of the foregoing embodiments, a surfactant is desirably employed to form the dispersion or latex. This surfactant is a monovalent salt of an alkaryloxypolyalkyleneoxysulfate.

Where any reference is made herein to any publication, patent, patent application or provisional patent application, the teachings thereof are incorporated herein in their entirety by reference.

Polar group modified polymers for use herein especially include derivatives of polyphenylene ethers or block copolymers of a vinyl aromatic monomer and a conjugated diene that have been modified by one or more chemical processes to include therein at least 0.1 to 10 mole percent of a polar functional group, preferably a carboxylic acid. Preferred polar group modified polymers for use herein are the foregoing polymers that have been grafted with an ethylenically unsaturated dicarboxylic acid or an anhydride thereof, especially maleic anhydride or fumaric acid.

Suitable polyphenylene ethers and processes for their preparation are well known and have been described in many publications, for example U.S. Pat. Nos. 3,306,874, 3,306,875, 3,639,656, 3,642,699, 3,219,625, 3,378,505 and 3,661,848. The processes most frequently used for the preparation of polyphenylene ethers comprise autocondensation of monohydric phenols in a solvent in the presence of oxygen and a catalyst. Preferred catalysts are metal-amine complexes, in particular copper-amine complexes. Preferred solvents are aromatic hydrocarbons.

Preferred polyphenylene ethers comprise a chain of alkyl-substituted benzene rings, preferably linked in the para-position via an oxygen atom. More preferred polyphenylene ethers are formed by oxidative coupling of a 2,6-dialkylphenol, including 2,6-dimethylphenol, 2,6-diethylphenol, 2-methyl-6-ethylphenol, 2-methyl-6-propylphenol, 2,6-dibutylphenol, 2,3,6-trimethylphenol, and mixtures thereof. Most preferred polyphenylene ethers are poly(2,6-dialkylphenols), especially poly(2,6-dimethylphenol). Suitable polymers are those having number average molecular weights (Mn) of from 10,000 to 90,000, preferably from 20,000 to 80,000. A suitable technique for measuring such polymer molecular weights is taught in Macromolecular Synthesis, 1 (1978), 83.

Suitable vinylaromatic/conjugated diene block copolymers include styrene/conjugated diene/styrene block copolymers comprising at least one polymeric block which comprises predominantly styrene monomer units and at least one polymeric block which comprises predominantly butadiene or isoprene monomer units. The block copolymer may be linear, branched, or radial, and the blocks may be prepared by sequential addition of monomers or by coupling. Linear block copolymers include those described in U.S. Pat. Nos. 3,231,635; 3,265,765 and 3,322,856. Coupled and radial block copolymers include polymers of the type described in U.S. Pat. Nos. 4,033,888; 4,077,893; 4,141,847; 4,391,949 and 4,444,953. Hydrogenated or partially hydrogenated derivatives of the foregoing polymers are included as well.

The proportion of vinylaromatic polymer blocks in the block copolymer is preferably between about 2 and about 65 percent by weight, and more preferably between about 5 and about 40 percent by weight. The vinylaromatic polymer blocks preferably have weight average molecular weights from 1,000 to 125,000, preferably from 2,000 to 60,000 and most preferably from 4,000 to 25,000. The conjugated diene blocks preferably have weight average molecular weights of 10,000 to about 450,000, preferably 15,000 to 150,000 and most preferably 20,000 to 100,000. The foregoing molecular weights are suitably measured using gel permeation chromatography and/or low angle light scattering techniques.

Hydrogenated derivatives of any of the foregoing block copolymers include all such polymers having ethylenic unsaturation, aromatic unsaturation or both ethylenic and aromatic unsaturation hydrogenated or partially hydrogenated. Hydrogenation preferably reduces the ethylenic unsaturation of the block copolymer to less than 10 percent of the original ethylenic unsaturation, more preferably to less than 2 percent. Aromatic unsaturation may remain or be reduced from that of the original polymer. Essentially fully hydrogenated block copolymers are those block copolymers wherein the aromatic unsaturation is reduced to less than 10 percent of the original aromatic unsaturation, more preferably reduced to less than 5 percent. In essentially aromatically unhydrogenated block copolymers, the aromatic unsaturation is preferably reduced by less than 10 percent of the original aromatic unsaturation by the selective hydrogenation thereof, and is more preferably reduced by less than 5 percent. Suitable techniques for the hydrogenation of block copolymers are known in the art, having been disclosed in U.S. Pat. Nos. 3,494,942; 3,634,594; 3,670,054; 3,700,633, 5,688,842 and Re 27,145, and elsewhere.

The polymer used in this invention must comprise polar functionality. Preferably, the polar functionality is grafted to the polymer after initial formation of the ungrafted polymer. Preferred polar functional groups include carboxylic acids, salts or anhydrides of carboxylic acids, sulfonic acids, salts or anhydrides of sulfonic acids, esters, alcohols, amines, epoxides and ketones. Carboxylic acids and their anhydrides are most preferred.

Graft functionalization of the polymer with a source of the desired polar functional group involves heating the polymer and source of the polar functional group, optionally in the presence of an initiator, such as an organic peroxide compound. Preferred sources of the polar functional group include unsaturated carboxylic acids or carboxylic acid derivatives, which may be monofunctional acids such as acrylic, methacrylic, cinnamic, crotonic, isocrotonic, mesaconic, or alpha-methylmesaconic acid and the like, or polyfunctional acids, such as maleic, fumaric, itaconic, citraconic acids and the like. Preferably, the corresponding anhydride derivative of a difunctional carboxylic acid, especially maleic anhydride is employed. The reaction may be performed in a molten state, such as in an extruder, or in a solution. Suitable graft functionalization techniques for use with respect to the foregoing polymers are taught in U.S. Pat. Nos. 3,375,228, 4,292,414, 4,308,353, 4,578,429, 4,771,096, 4,654,405, and 5,346,963.

Polar group functionalized polymers useful in this invention preferably contain from 0.1 to 10 weight percent, more preferably from 0.1 to 5 weight percent polar functional groups. When used as a coating of a reinforcing agent, lesser amounts of polar functional groups generally attain decreased adhesion to the reinforcing agent or require increased quantities of silane or other coupling agent in order to obtain adequate product properties. Use of amounts of polar functional groups in excess of 10 weight percent generally does not achieve improvement in desired properties and is uneconomical.

Suitable alaryloxypolyalkyleneoxysulfate surfactants for use herein correspond to the formula:

[R¹—Ar—(OR²)ₙ—O—SO₃]⁻X⁺

wherein,

R¹ is a linear or branched, C₅₋₂₄ alkyl group;

Ar is a C₆₋₁₂ aryl group, or a mono- or poly- C₁₋₄ alkyl substituted aryl group;

R² independently each occurrence is a C₂₋₄ alkylene group,

n is a number from 1 to 5 indicating the average number of OR² groups; and

X⁺ is monovalent cation, preferably Na⁺, K⁺ or NH₄⁺.

A preferred alkaryloxypolyalkyleneoxysulfate surfactant is ammonium nonylphenoxytetra(ethoxy)sulfate (C₉H₁₉C₆H₄(OCH₂CH₂)ₙOSO₃ NH₄), where n is four. This surfactant is sold commercially under the tradename Rhodapex® CO-436 by Rhodia Inc.

The viscosity of the resulting dispersion or latex may be adjusted by addition of a thickener or by dilution with additional quantities of water if desired. The particular thickener utilized is not critical and a wide variety may be utilized. Thickeners may be simple viscosity modifiers or may also function as thixotropic agents. Thixotropic agents are incorporated in suspension or emulsion compositions to raise low-shear viscosities while retaining a low, high-shear viscosity. Thixotropic agents permit stirring, mixing, and application of the dispersion to substrates but reduce running and dripping of the dispersion after application to substrates. The amount of thickening agent required depends somewhat on the effectiveness of the particular thickening agent utilized, but generally about 0.1 to 30 weight percent based on total formulation weight may be employed. Acceptable classes of thickening agents include soap gels, lipophilic fatty acid esters, polysaccharide gums, water soluble cellulose derivatives, clays and alumina gels. Useful thickeners which also function as thixotropic agents include organo clays. Organo clays are clays treated with quaternary ammonium compounds. Specific examples include dimethyl di(hydrogenated tallow) ammonium chlorides, dimethyl(hydrogenated tallow) benzylammonium chloride and methyl di(hydrogenated tallow) benzylammonium chloride. Commercial organo clay products which are usefully employed herein include Cyanamer™ P-250, available from American Cyanamid Co., and Acrysol™ ASE and Acrysol™ RM-5, available from Rohm and Haas Company.

The dispersion or latex may contain other known additives, such as fillers, pigments, antioxidants and crosslinking agents. The foregoing, thickeners, thixotropic agents and other components may be either in the aqueous phase, the dispersed phase, in a phase separate from both the dispersed phase or the water phase, or in a combination of the foregoing.

The aqueous phase is preferably present in an amount between about 50 and about 900 parts by weight based on 100 parts by weight of polymer. More preferably, the amount of water is between about 100 and about 300 parts by weight based on 100 parts by weight of functionalized polymer. With less water, the dispersion or latex has a relatively high viscosity. Larger amounts of water are generally not preferred due to the increased volume of material to be processed.

To make a dispersion according to the invention, the polar group functionalized polymer is dissolved or prepared in a suitable solvent that is not miscible with the aqueous phase, such as an oleophilic liquid solvent. Examples include toluene, alkanes and chlorinated aliphatic hydrocarbons. If the polar group functionalized polymer is prepared in a solvent, the dispersion may be prepared directly without first isolating the polymer, if desired. This solution is combined with the remaining components of the dispersion and processed under high shear conditions at a temperature from about 10 to 250° C. for a time sufficient to form the dispersion. In this embodiment of the invention, it may be desirable to first remove interfering components from the reaction mixture. For example, unreacted functionalizing agents, such as maleic anhydride or fumaric acid or initiator residue, may desirably be removed from the reaction mixture by use of ultra-filtration, reverse osmosis, or similar technique, prior to or after forming the dispersion. To form a latex, the resulting dispersion is treated in order to remove the solvent, thereby leaving the polymer in a dispersed solid form in the aqueous continuous phase. A preferred method of removing the solvent is heating, optionally finider reduced pressure. Alternatively, the latex may be formed directly from the polymer if it is first cryogenically ground to a fine particle size, such as 60 mesh (250 μm volume average particle size or less), and added to the aqueous medium under conditions of high shear, preferably at a temperature above the glass transition temperature of the polymer.

A number of high shear mixing devices and techniques may be utilized to form the dispersion. Examples of suitable dispersers include, but are not restricted to, a rotating shaft within a sleeve-type disperser, as described by Warner et al. in U.S. Pat. No. 4,123,403; a high-shear stator rotor; an extruder, a submerged jet, or a centrifugal pump-head. One particularly suitable disperser is a Model M11OET Microfluidizer, available from Microfluidics Corp., Newton, Mass. This device heats a polymer slurry to above 200° C. under a high pressure, passes the slurry through two interaction chambers in series, and then rapidly cools the dispersion to near ambient temperature. The chambers contain channels that provide a focused interaction zone of intense turbulence causing a release of energy amid both cavitation and shear forces. Velocities in excess of 1500 feet per second (460 m/s) are achieved and a pressure of 16,000 psi (110 Mpa) is utilized. The slurry may be repeatedly passed through the disperser until a dispersion of the desired properties is obtained. The dispersion is rapidly cooled in order to prevent reagglomeration of the dispersed phase. Removal of the solvent during the foregoing procedure or subsequent thereto results in latex formation.

The dispersion or latex may have a multimodal distribution of particles or a monomodal distribution of particles. Preparation of monomodal, high internal phase volume dispersions and latexes are desirable to enable formation of uniform sized, small particle volume dispersions. Such dispersions are particularly desired in order to prepare uniform coatings of the polar group functionalized polymer on the surface of extremely small particle sized inorganic particles.

The dispersions and latexes of the present invention can be used for applications normally associated with dispersions or latexes. For example, coatings, paints, adhesives, sealants, caulks, carpet backing, and solid film articles such as gloves and condoms may be prepared therefrom, using standard methods well known to the skilled artisan. When employed to coat fibrous articles for reinforcement of thermoplastic polymers, use of a latex according to the present invention, especially a latex of a polar group modified polyphenylene ether, rather than an emulsion or coating thereof, beneficially reduces the quantity of volatile components, such as organic solvent, emitted during the coating and drying process. Surprisingly, it has now been discovered that the resulting coated fibers retain the beneficial properties obtainable by the use of organic coatings of the same polymer, such as adhesion to thermoplastic resins, and compatibility with sizing agents or compatibilizing agents, while achieving reduced hydrocarbon emissions due to use of a latex rather than an emulsion.

Having described the invention, the following examples are provided as further illustrative and are not to be construed as limiting. The skilled artisan will appreciate that the invention disclosed herein may be practiced in the absence of any component that has not been specifically disclosed. Unless stated to the contrary, all parts and percentages are based on weight. The maleated polyphenylene ether polymers prepared in the following examples are considered to be equivalent to one another, and are referred to as MAPPO or FAPPO, depending on whether the maleating agent is maleic anhydride or fumaric acid, respectively.

### EXAMPLE 1

1500 grams of a fumaric acid modified polyphenylene ether polymer in the form of pellets was prepared by melt blending in an extruder a mixture of poly(2,6-dimethylphenol) (97 percent), fumaric acid (1.8 percent) and 2,3-dimethyl-2,3-diphenylbutane initiator (1.2 percent). The graft level of the resulting polymer, as measured by titration, was 0.8 percent. The pellets were dissolved in 3500 grams of toluene at 95° C. by stirring in a round bottom flask for several days. Aammonium nonylphenoxytetra(ethoxy)sulfate (108g, Rhodapex® CO-436 available from Rhodia Inc.), was added to the polymer solution and the polymer solution was dispersed in water at room temperature using the continuous process described in U.S. Pat. No. 5,124,073. The resulting product was a smooth, oil-in-water type emulsion. Toluene was stripped from the product in a rotary evaporator at 80 to 85° C. The final solvent-free dispersion (latex) contained 40 weight percent solids and had a mean volume average particle diameter of 1.0-1.1 μm as measured by use of a LS 130 Particle Size Analyzer, available from Coulter, Inc.

### EXAMPLE 2

30 grams of fumaric acid modified poly(2,6-dimethylphenol) polymer pellets (prepared as in Example 1) were dissolved in 70 grams of toluene. The polymer solution and 2.7 grams of ammonium nonylphenoxytetra(ethoxy)sulfate, sold commercially under the tradename Rhodapex® CO-436 by Rhodia Inc. were added to a 16-oz (470 ml) glass jar. The jar was placed in a water bath set at 65° C. and the contents were mixed for about 1 minute using a Caframo brand mixer with a 20-inch (50 cm) Cowles blade at a speed of 3000 rpm. Water at 25° C. was added slowly in 10 ml aliquots every 30 to 60 seconds while continuously mixing. The emulsion began as a water-in-oil emulsion but flipped to an oil in water emulsion when 20 to 25 ml of water had been added. After a total of 100 ml of water was added, the jar was removed from the water bath and allowed to cool to room temperature. The final emulsion was smooth and creamy and remained stable at room temperature for several weeks after formation.

### EXAMPLE 3

Blendex™ BHPP820 polyphenylene ether (available from General Electric Chemicals) and maleic anhydride (at 5 parts per 100 parts polyphenylene ether) were dissolved at 80° C. in chlorobenzene to form a 40 percent polymer solution. The radical initiator, 1,1-bis(t-butylperoxy)-3,3,5-trimethylcyclohexane was added at 5 parts per 100 parts polyphenylene ether and the solution was agitated at 90° C. for 4 hours to form a solution of maleic anhydride grafted polyphenylene ether with about 0.8 percent functionalization. One hundred grams of the polymer solution were heated to 80° C. and combined with 5.2 grams of ammonium nonylphenoxytetra(ethoxy)sulfate (Rhodapex® CO-436 available from Rhodia Inc.), in a 16-oz (470 ml) glass jar. The jar was placed in a water bath set at 80° C. and the contents were mixed for about 1 minute using a Caframo mixer with a 20 inch (50 cm) Cowles blade at a speed of 3000 rpm. Water at 80° C. was added slowly in 10 ml aliquots every 30-60 seconds while continuously mixing. The emulsion began as a water-in-oil emulsion but flipped to an oil in water emulsion when about 20 ml of water had been added. After a total of 70 ml of water were added, the jar was removed from the water bath and allowed to cool to about 25° C. Chlorobenzene was stripped in a rotary evaporator at 70° C. The resulting latex had a mean volume particle diameter of 1.25 μm as measured by a particle size analyzer (model LS 130™ available commercially from Coulter, Inc).

### EXAMPLE 4

4974 grams toluene and 561 grams 1-butanol were added to a 20-liter round bottom flask and swirled until well mixed. 2975 grams of fumaric acid modified poly(2,6-dimethylphenol) polymer pellets (prepared as in Example 1) were added to the solvent. After sitting overnight, the flask was heated to 85° C. in a water bath with stirring. The polymer dissolved into a dark, homogeneous solution within 2- to 3 hours. The polymer solution was dispersed in water at 70° C. using the continuous process described in U.S. Pat. No. 5,124,073. The resulting product was a smooth, oil-in-water type emulsion. Solvent was stripped from the product in a rotary evaporator at 85° C. The final solvent-free latex dispersion had a solids content of 47 percent and had a mean volume particle diameter of 0.29 μm as measured by a particle size analyzer (model LS 130™ available from Coulter, Inc.).

### EXAMPLE 5

The latex of Example 1 was included in the sizing formulation coated onto chopped fibers of E-glass having average diameter of 10 gm (PPG 3540, available from PPG Corporation) to provide varying amounts of FAPPO on the surface of the glass. The amount of FAPPO was determined by pyrolysis/gas chromatography/mass spectroscopic analysis (pyrolysis/GS/MS). The dried, coated, glass was compounded into syndiotactic polystyrene (SPS) in a twin screw extruder to give a 30 percent glass loading, then injection molded to form test bars. Comparative resins made without FAPPO coated glass, and without FAPPO coated glass but with FAPPO added to the blend were produced as well. Results are contained in Table 1.

TABLE 1

| | | % FAPPO | Unnotched | Notched | | | Tensile | DTUL |
|---|---|---|---|---|---|---|---|---|
| | % FAPPO | in | Izod | Izod | Er | Tr | modulus × | 264 psi |
| Run | on glass | composition | ft-lb/in | ft-lb/in | (%) | psi × 10⁴ | 10⁶ | (° F.) |
| 1* | 0.0 | 0.0 | 3.3 | 0.9 | 1.1 | 1.25 | 1.22 | 395 |
| 2 | 1.8 | 0.5 | 7.3 | 1.2 | 1.7 | 1.56 | 1.19 | 418 |
| 3 | 4.1 | 1.2 | 10.7 | 1.9 | 1.7 | 1.73 | 1.28 | 446 |
| 4 | 6.8 | 2.0 | 10.6 | 1.8 | 1.6 | 1.66 | 1.30 | 441 |
| 5** | 0.0 | 2.0 | 11.7 | 2.0 | 1.7 | 1.83 | 1.31 | 451 |

*Comparative, not an example of the invention, no FAPPO in composition
**Comparative, not an example of the invention, FAPPO not coated onto glass fibers

These results show that improved composition properties are obtained by use of a filler coated with maleated polyphenylene ether modifier applied from an emulsion. More particularly, at 4.1 weight percent FAPPO loading on glass (corresponding to 1.2 weight percent total FAPPO in the composite), the properties of the composition are essentially comparable to those of the control containing 2 weight percent FAPPO added to the composite during compounding. Therefor, less modifier is required to obtain equivalent performance if the modifier is coated onto the filler material from an emulsion rather than blending the modifier resin into the composite matrix during compounding.

1. An aqueous dispersion of a polar group modified polyphenylene ether or a polar group modified block copolymer of a vinyl aromatic monomer and a conjugated diene, said dispersion having a mean, volume average particle size dispersed phase of less than 2.0 μm.

2. The aqueous dispersion of claim 1 comprising a surfactant selected from the group consisting of monovalent salts of alkaryloxypolyalkyleneoxysulfates, having the formula:
[R¹—Ar—(OR²)ₙ—O—SO₃]⁻X⁺
wherein,
R¹ is a linear or branched, C₅₋₂₄ alkyl group;
Ar is a C₆₋₁₂ aryl group, or a mono- or poly- C₁₋₄ alkyl substituted aryl group;
R² independently each occurrence is a C₂₋₄ alkylene group,
n is a number from 1 to 5 indicating the average number of OR² groups; and
X⁺ is Na⁺, K⁺, or NH₄⁺.

3. The aqueous dispersion of claim 2 wherein X⁺ is NH₄⁺.

4. The aqueous dispersion of claim 1 which is a dispersion of a polar group functionalized polyphenylene ether.

5. The aqueous dispersion of claim 4 wherein the polar group functionalized polyphenylene ether is maleic anhydride or fumaric acid grafted poly(2,6-dimethylphenol), containing from 0.1 to 10 mole percent maleic anhydride or fumaric acid.

6. The aqueous dispersion of claim 1 which is a latex.

7. The aqueous dispersion of claim 4 which is a latex.

8. A composition comprising: 1) a thermoplastic resin and 2) an inorganic filler, characterized in that the filler initially comprises a coating on the surface thereof formed from a latex according to claim 7.

9. The composition of claim 8 wherein the inorganic filler is in the form of a fiber.

10. The composition of claim 9 wherein the inorganic filler is fiber glass.

11. The composition of any one of claims 8-10 wherein the thermoplastic resin is syndiotactic polystyrene.
